(19) United States
(12) Patent Application Publication
(10) Pub. No.: US 2025/0317326 A1
(43) Pub. Date: Oct. 9, 2025

(54) BANDWIDTH AND SCALING IMPROVEMENTS FOR SDWAN HIGH AVAILABILITY CLUSTERS

(71) Applicant: Cisco Technology, Inc., San Jose, CA (US)

(72) Inventors: Arul Murugan Manickam, San Jose, CA (US); Pritam Baruah, Fremont, CA (US); Avinash Shah, Pleasanton, CA (US); Michael Tracy, Petaluma, CA (US); Sampath Sthothra Bhasham, Santa Clara, CA (US)

(21) Appl. No.: 18/675,398

(22) Filed: May 28, 2024

Related U.S. Application Data
(60) Provisional application No. 63/631,903, filed on Apr. 9, 2024.

(51) Int. Cl. H04L 12/46; H04L 45/586

(52) U.S. Cl. CPC H04L 12/4641; H04L 45/586

(57) ABSTRACT

The present technology uses stateless virtual private network (VPN) homing to assign one of the nodes as an active node and the other as a standby node. When the packet is received at the active node and return traffic received at the standby node, the standby node can redirect the traffic to the VPN-homed active node since the VPN is stateless and therefore the resetting by the stateful application will not occur. Multiple VPNs can be implemented to route more business-critical traffic across an active node while still permitting the other node to be active in a second VPN for less critical traffic. The nodes can therefore be used more efficiently but without the session reset problem inherent in stateful application configurations.

### CROSS-REFERENCE TO RELATED APPLICATIONS

This application claims priority to U.S. Patent Application No. 63/631,903, filed Apr. 9, 2024, the contents of which are hereby incorporated by reference in their entirety.

### BACKGROUND

High availability (HA) network designs can be configured differently for various HA pairs. For example, the pairs may be configured as Active/Standby, Active/Hot-Standby, Active/Passive-Active, or Active/Active. In the case of Active/Standby mode, the standby router will not transfer traffic if it receives return traffic from, e.g., a data center. This is due to the fact that a key requirement for the stateful application to work is to inspect the bidirectional packet flow, otherwise the session will be reset. If the packet returns to a standby node without bidirectional packet flow inspection, the stateful application will reset the flow because there is no way for the standby node to know the flow owner. This results in the standby node being unable to forward the packet to an active node.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example of a high-level network architecture in accordance with some embodiments;

FIG. 2 illustrates a routine in accordance with some embodiments.

FIG. 3A illustrates a schematic diagram of a HA cluster network in accordance with some embodiments.

FIG. 3B illustrates another schematic diagram of a HA cluster network with return traffic routed to the standby node in a stateful application configuration, in accordance with some embodiments.

FIG. 3C illustrates a schematic diagram of a HA cluster in a stateless configuration with a first node in the active state and return traffic routed to the second node, in accordance with some embodiments.

FIG. 3D illustrates a schematic diagram of a HA cluster in a stateless configuration with a second node in the active state and return traffic routed to the second node, in accordance with some embodiments.

FIG. 4 illustrates an example communication network including one or more autonomous systems (ASes) in accordance with some aspects of the present technology; and

FIG. 5 illustrates an example network device in accordance with some examples of the disclosure.

### DETAILED DESCRIPTION

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

HA clusters are designed to provide continuous operational performance by minimizing downtime and ensuring that there is no single point of failure. They achieve this through redundancy, i.e., automatically switching to a standby node in the event of a failure, thus maintaining service continuity. Additionally, HA clusters can enhance system scalability and load balancing, distributing workloads across multiple nodes to optimize resource use and improve overall system performance.

Many HA clusters include two separate paths of uplinks, one for each node. In the active/standby configuration, the active node uplinks are used continuously but the standby node's uplinks are not used at all unless the active node fails or loses connectivity. Many network designs therefore allow active/active traffic forwarding to better utilize both sets of uplinks. However, return traffic could land on any node in the HA cluster. This is problematic because one requirement for the stateful application to function properly is to inspect bidirectional packet flow. Otherwise, the session will be reset.

The present technology addresses the need to use both sets of uplinks while also avoiding session resetting. To achieve this, the present technology uses stateless virtual private network (VPN) homing to assign one of the nodes as an active node and the other as a standby node. For example, the first node can establish multiple stateless VPNs to designate the first node as active in a first VPN, and the second node as active in a second VPN. When the packet is received at the active node and return traffic received at the standby node, the standby node can redirect the traffic to the VPN-homed active node since the VPN is stateless and therefore the resetting by the stateful application will not occur. Thereafter, the active node can transmit the packet according to the defined protocol for load balancing. For example, VPNs can be established to route critical traffic through a first node while a second VPN operates to route less critical traffic through a second node.

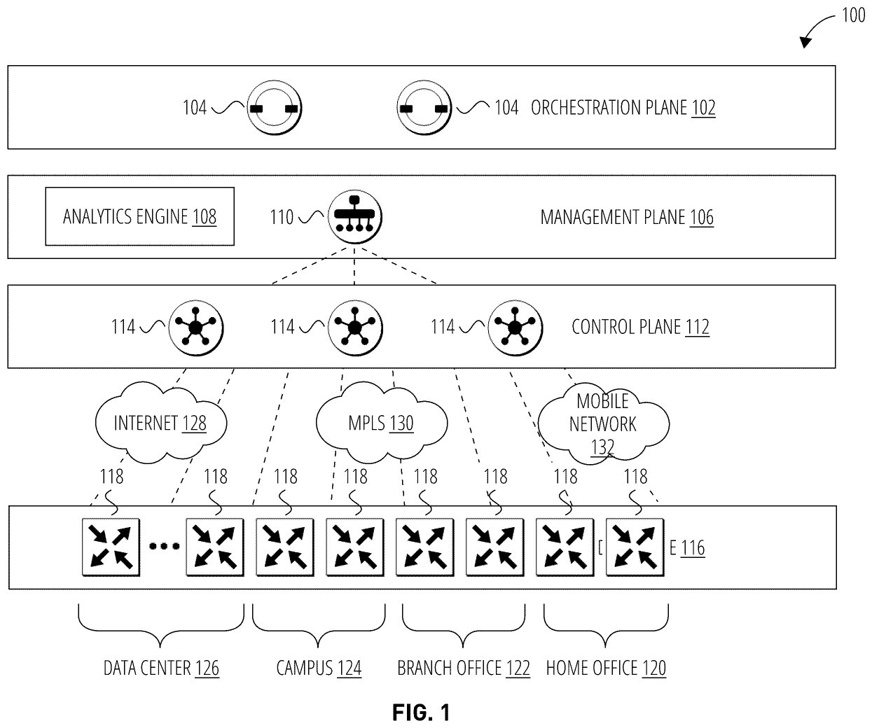

FIG. 1 illustrates an example of a network architecture 100 for implementing aspects of the present technology. An example of an implementation of the network architecture 100 is the Cisco® SD-WAN architecture. However, one of ordinary skill in the art will understand that, for the network architecture 100 and any other system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network architecture 100 can comprise an orchestration plane 102, a management plane 106 with an analytics engine 108, a control plane 112, and a data plane 116. The orchestration plane 102 can assist in the automatic on-boarding of edge network devices 118 (e.g., switches, routers, etc.) in an overlay network. The orchestration plane 102 can include one or more physical or virtual network orchestrator appliances 104. The network orchestrator appliances 104 can perform the initial authentication of the edge network devices 118 and orchestrate connectivity between devices of the control plane 112 and the data plane 116. In some embodiments, the network orchestrator appliances 104 can also enable communication of devices located behind Network Address Translation (NAT). In some embodiments, physical or virtual Cisco® SD-WAN vBond appliances can operate as the network orchestrator appliances 104.

The management plane 106 can be responsible for central configuration and monitoring of a network. The management plane 106 can include one or more physical or virtual network management appliances 110. In some embodiments, the network management appliances 110 can provide centralized management of the network via a graphical user interface to enable a user to monitor, configure, and maintain the edge network devices 118 and links (e.g., internet transport network 128, MPLS network 130, 4G/Mobile network 132) in an underlay and overlay network. The network management appliances 110 can support multi-tenancy and enable centralized management of logically isolated networks associated with different entities (e.g., enterprises, divisions within enterprises, groups within divisions, etc.). Alternatively or in addition, the network management appliances 110 can be a dedicated network management system for a single entity. In some embodiments, physical or virtual Cisco® SD-WAN vManage appliances can operate as the network management appliances 110.

The control plane 112 can build and maintain a network topology and make decisions on where traffic flows. The control plane 112 can include one or more physical or virtual network control appliances 114. The network control appliances 114 can establish secure connections to each edge network device 118 and distribute route and policy information via a control plane protocol (e.g., Overlay Management Protocol (OMP) (discussed in further detail below), Open Shortest Path First (OSPF), Intermediate System to Intermediate System (IS-IS), Border Gateway Protocol (BGP), Protocol-Independent Multicast (PIM), Internet Group Management Protocol (IGMP), Internet Control Message Protocol (ICMP), Address Resolution Protocol (ARP), Bidirectional Forwarding Detection (BFD), Link Aggregation Control Protocol (LACP), etc.). In some embodiments, the network control appliances 114 can operate as route reflectors. The network control appliances 114 can also orchestrate secure connectivity in the data plane 116 between and among the edge network devices 118. For example, in some embodiments, the network control appliances 114 can distribute crypto key information among the edge network devices 118. This can allow the network to support a secure network protocol or application (e.g., Internet Protocol Security (IPSec), Transport Layer Security (TLS), Secure Shell (SSH), etc.) without Internet Key Exchange (IKE) and enable scalability of the network. In some embodiments, physical or virtual Cisco® SD-WAN vSmart controllers can operate as the network control appliances 114.

The data plane 116 can be responsible for forwarding packets based on decisions from the control plane 112. The data plane 116 can include the edge network devices 118, which can be physical or virtual edge network devices. The edge network devices 118 can operate at the edges various network environments of an organization, such as in one or more data centers 126, campus networks 124, branch office networks 122, home office networks 120, and so forth, or in the cloud (e.g., Infrastructure as a Service (IaaS), Platform as a Service (PaaS), SaaS, and other cloud service provider networks). The edge network devices 118 can provide secure data plane connectivity among sites over one or more WAN transports, such as via one or more internet transport networks 128 (e.g., Digital Subscriber Line (DSL), cable, etc.), MPLS networks 130 (or other private packet-switched network (e.g., Metro Ethernet, Frame Relay, Asynchronous Transfer Mode (ATM), etc.), mobile networks 132 (e.g., 3G, 4G/LTE, 5G, etc.), or other WAN technology (e.g., Synchronous Optical Networking (SONET), Synchronous Digital Hierarchy (SDH), Dense Wavelength Division Multiplexing (DWDM), or other fiber-optic technology; leased lines (e.g., T1/E1, T3/E3, etc.); Public Switched Telephone Network (PSTN), Integrated Services Digital Network (ISDN), or other private circuit-switched network; small aperture terminal (VSAT) or other satellite network; etc.). The edge network devices 118 can be responsible for traffic forwarding, security, encryption, quality of service (QOS), and routing (e.g., BGP, OSPF, etc.), among other tasks. In some embodiments, physical or virtual Cisco® SD-WAN vEdge routers can operate as the edge network devices 118.

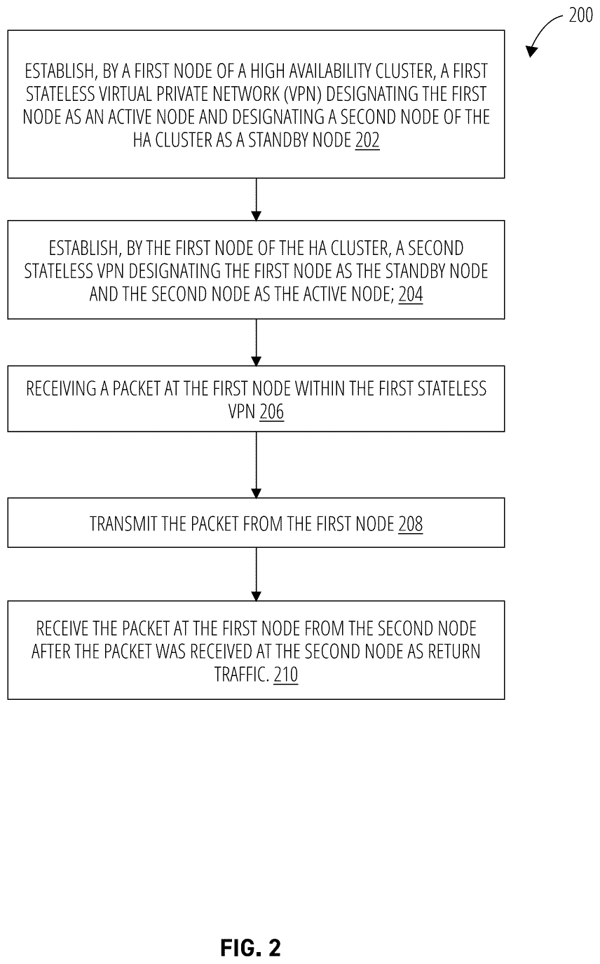

FIG. 2 illustrates a routine in accordance with one embodiment of the present technology. The routine 200 allows for multiple stateless VPNs to run on the HA cluster so that different nodes of the HA cluster can be designated as active or standby as needed. This allows for use of both sets of uplinks in a two node system, but avoids the issue of session reset that is so prominent in configurations with a stateful application.

In block 202, routine 200 establishes a first stateless VPN designating a first node in the HA cluster as an active node and designating a second node of the HA cluster as a standby node. For example, the first node of the HA cluster can establish a first stateless VPN designating a first node in the HA cluster as an active node and designating a second node of the HA cluster as a standby node. The active node can therefore perform packet forwarding duties, while the standby node can standby as needed if the active node loses connectivity or fails for any reason. In some embodiments, the standby node performs packet processing on the packet.

In block 204, routine 200 establishes a second stateless VPN designating the first node as the standby node and the second node as the active node. For example, the first node of the HA cluster can establish a second stateless VPN designating the first node as the standby node and the second node as the active node. Of course, any number of nodes or VPNs can be implemented without departing from the spirit and scope of the present technology. The reference to a first and second node, and a first and second stateless VPN, is simply to describe that the routine 200 can be implemented across a plurality of nodes and stateless VPNs.

In block 206, routine 200 receives a packet at the first node within the first stateless VPN. In addition, the routine 200 may determine which of the first node and the second node is the active node, and cause the packet to be received at the active node based on that determination. For example, the packet can be received from a branch and routed to the first node based on a determination made by, for example, a label switch router (LSR). For example, the determining can be conducted by attaching a label at the ingress interface of the HA cluster 304 and designating the first stateless VPN or the second stateless VPN as the VPN responsible for routing the packet. The packet can then be routed to the active router as designated by the appropriate VPN, by inspecting the label of the packet and determining that the label designates the first stateless VPM or the second stateless VPN as the VPN responsible for routing the packet.

In block 208, routine 200 transmits the packet from the first node. For example, the first node can transmit the packet to a data center (DC) based on the destination address of the packet or any other routing methodology.

In block 210, routine 200 receives the packet at the first node from the second node after the packet was received at the second node as return traffic. For example, the receiving the packet at the first node from the second node can be conducted across a peer link of the HA cluster. In the conventional stateful application configuration, the session would be reset upon the second node receiving the packet from the DC. This is because the second node would not know the flow owner and the second node would be in standby mode. However, in the routine 200, the packet would be forwarded to the first node by the second node because the second node would know the flow owner due to the stateless VPN that is active at the time. Thereafter, the first node can then transmit the packet out of the HA cluster after receiving the packet from the second node.

The first and second stateless VPNs can be established on any basis. For example, the first stateless VPN and second stateless VPN can designate the active node as a routing device responsible for routing traffic that is more critical than traffic routed by the standby node. This allows for multiple VPNs to run at the same time with different preferences given to different traffic based on their criticality. For example, in a two node system, a first VPN can designate the first node as active and the second node as standby. This first VPN can be for business critical applications such that the active node is responsible for routing data traffic, while the second node will become active in the event of failure or a loss of connectivity by the first node. A second VPN can also run at the same time and handle less critical traffic with the second node being designated as active and the first node designated as standby. Here, the traffic can be load balanced through this VPN homing and more efficiently use both nodes.

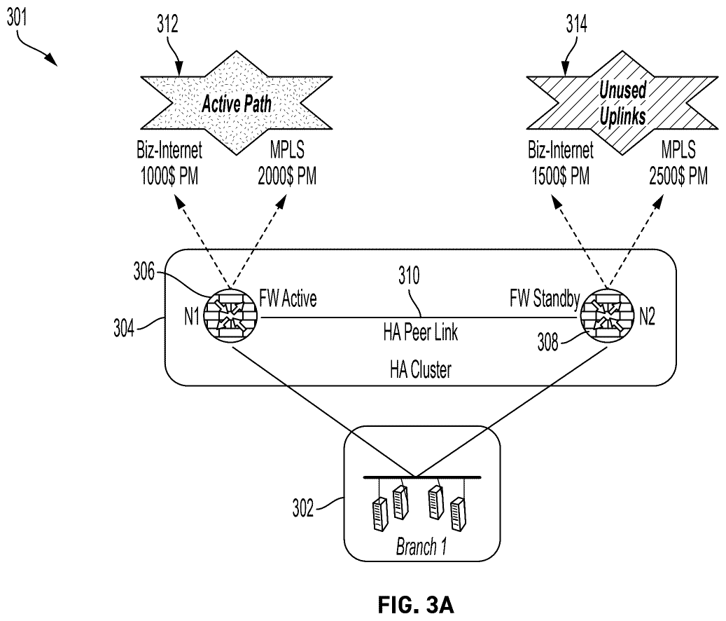

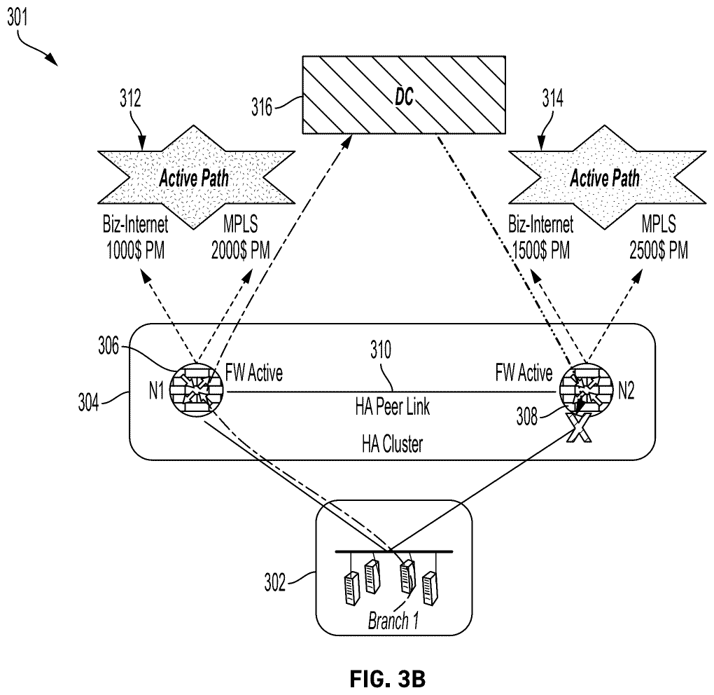

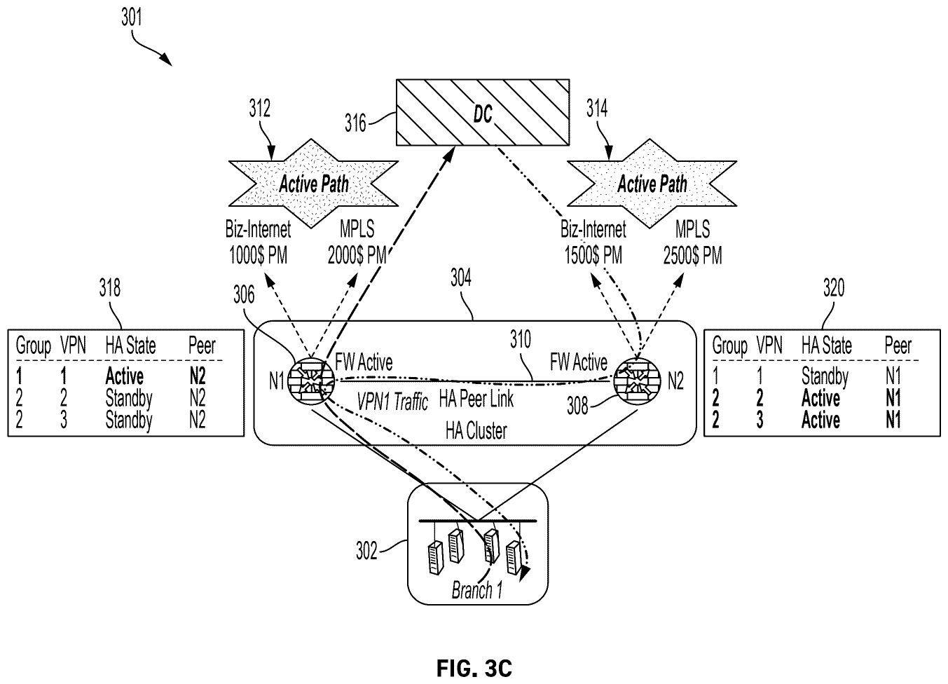

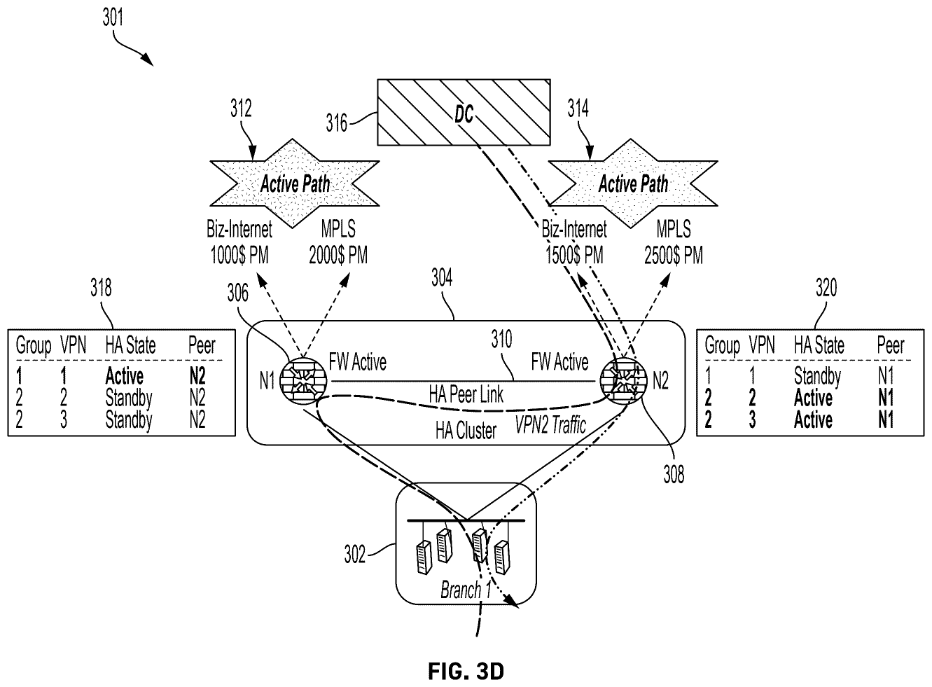

FIGS. 3A-3D illustrate schematic diagrams of a HA cluster network 301 in accordance with embodiments of the present technology. As shown, the HA cluster network 301 includes branch 302 that is communicably coupled to a HA cluster 304. The HA cluster 304 includes a first node 306 and a second node 308 communicably coupled by a peer link 310. Data packets can egress from the HA cluster 304 either at a first path 312 of data uplinks associated with the first node 306 or a second path 314 of data uplinks associated with the second node 308. As shown in FIG. 3B-3D, the first path 312 and second path 314 can be communicably coupled to a data center 316.

FIG. 3A illustrates a configuration where the first node 306 is in active mode and the second node 308 is in standby mode. As shown, data packets are transmitted from the branch 302 into the HA cluster 304 and to the first node 306 since the first node 306 is the active node. The first node 306 can then transmit the data packet across the uplinks of the first path using services requiring monthly fees for that path. However, the second node 308 does not transmit any traffic until the first node 306 fails or loses connectivity. In this case, the second node 308 requires capital expenditures for the service of the second path 314. However, the second node 308 and second path 314 remain unused.

FIG. 3B illustrates the problem with a stateful application configuration. Here, the data packet is transmitted from the branch 302 into the HA cluster 304 and to the active node, which here is the first node 306. The first node 306 can then transmit the packet across the first path 312 to the data center 316. The data center 316 does not know which node of the HA cluster 304 is the active node, since the HA cluster merely advertises its address rather than that of the active node. So, the data center 126 routes the packet back to the HA cluster 304 via the second node 308. In the stateful application configuration, the session would then be reset because the second node 308 would not know the flow owner of the packet.

FIG. 3C illustrates a schematic diagram of a HA cluster in a stateless configuration with a first node in the active state and return traffic routed to the second node, in accordance with some embodiments. Here, the packet is routed much like as discussed above with respect to FIG. 3B, with return traffic routed to the standby node. Here, however, the HA cluster has established three separate stateless VPNs, which are described in a first VPN table 318 associated with the first node 306, and a second VPN table 320 associated with the second node 308. As shown, the first VPN table 318 includes three separate groups that establish active and standby nodes for different types of network traffic. Here, assume the packet belongs to the first VPN, which designates the first node 306 as the active node and the second node 308 as the standby node. The second node 308 can therefore receive the data packet as return traffic from the data center 316, and reference the second VPN table 320 to identify the first node 306 as the flow owner of the packet. Thereafter, the second node 308 can transmit the data packet back to the first node 306 for further routing. For example, the second node 308 can transmit the data packet to the first node 306 across the peer link 310 of the HA cluster 304. The first node 306 can then transmit the data packet out of the HA cluster 304 as necessary based on, for example, a destination address of the packet.

FIG. 3D illustrates a schematic diagram of a HA cluster network 301 in a stateless configuration with the second node 308 in the active state and return traffic routed to the second node 308, in accordance with some embodiments. As shown, here the active node is the second node 308 and the first node 306 is in standby mode. The packet is routed to the first node 306 despite it being in standby mode. For example, the ingress interface can attach a label to the packet to designate a specific VPN based on, for example, the criticality of the data in the packet. When returning from the data center 126, the VPN cloud can attach the same label as an attribute of the overlay transport layer and the ingress interface can direct the packet to the appropriate node based on the active node in the relevant VPN.

But why route to the standby node when receiving the packet from the branch 302? Here, the standby node can conduct internal packet processing from within the HA cluster 304 after receiving the packet from the branch 302. For example, the standby node can perform load balancing, manage session persistence, and execute SSL termination to offload processing tasks from active nodes. It can also engage in health monitoring, ensuring all nodes are ready to handle requests, and handle caching to improve response times. Additionally, the standby node can manage failover processes, seamlessly taking over traffic when an active node fails, and conduct security operations such as traffic filtering and intrusion detection to maintain the integrity and security of the network. Any other form of packet processing can be conducted by the standby node without departing from the spirit and scope of the present technology. After performing packet processing, the standby node (here, the first node 306) can transmit the packet to the active node (here, the second node 308) across the peer link 310.

A computer network is a geographically distributed collection of nodes interconnected by communication links and segments for transporting data between end nodes, such as personal computers and workstations, or other network devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other.

Since management of interconnected computer networks can prove burdensome, smaller groups of computer networks may be maintained as routing domains or autonomous systems. An Autonomous System (AS) is a network or group of networks under common administration and with common routing policies. A typical example of an AS is a network administered and maintained by an Internet Service Provider (ISP). Customer networks, such as universities or corporations, connect to the ISP, and the ISP routes the network traffic originating from the customer networks to network destinations that may be in the same ISP or may be reachable only through other ISPs.

To facilitate the routing of network traffic through one or more ASes, the network elements of the ASes need to exchange routing information to various network destinations. Border Gateway Protocol (BGP) is an Exterior Gateway Protocol (EGP) that is used to exchange routing information among network elements (e.g., routers) in the same or different ASes. A computer host that executes a BGP process is typically referred to as a BGP host or a BGP network device. To exchange BGP routing information, two BGP hosts, or peers, first establish a transport protocol connection with one another. Initially, the BGP peers exchange messages to open a BGP session, and, after the BGP session is open, the BGP peers exchange their entire routing information. Thereafter, only updates or changes to the routing information are exchanged, or advertised, between the BGP peers. The exchanged routing information is maintained by the BGP peers during the existence of the BGP session.

The networks within an AS are typically coupled together by conventional “intradomain” routers configured to execute intradomain routing protocols, and are generally subject to a common authority. To improve routing scalability, a service provider (e.g., an ISP) may divide an AS into multiple “areas” or “levels.” It may be desirable, however, to increase the number of nodes capable of exchanging data; in this case, interdomain routers executing interdomain routing protocols are used to interconnect nodes of the various ASes. Moreover, it may be desirable to interconnect various ASes that operate under different administrative domains. As used herein, an AS, area, or level is generally referred to as a “domain.”

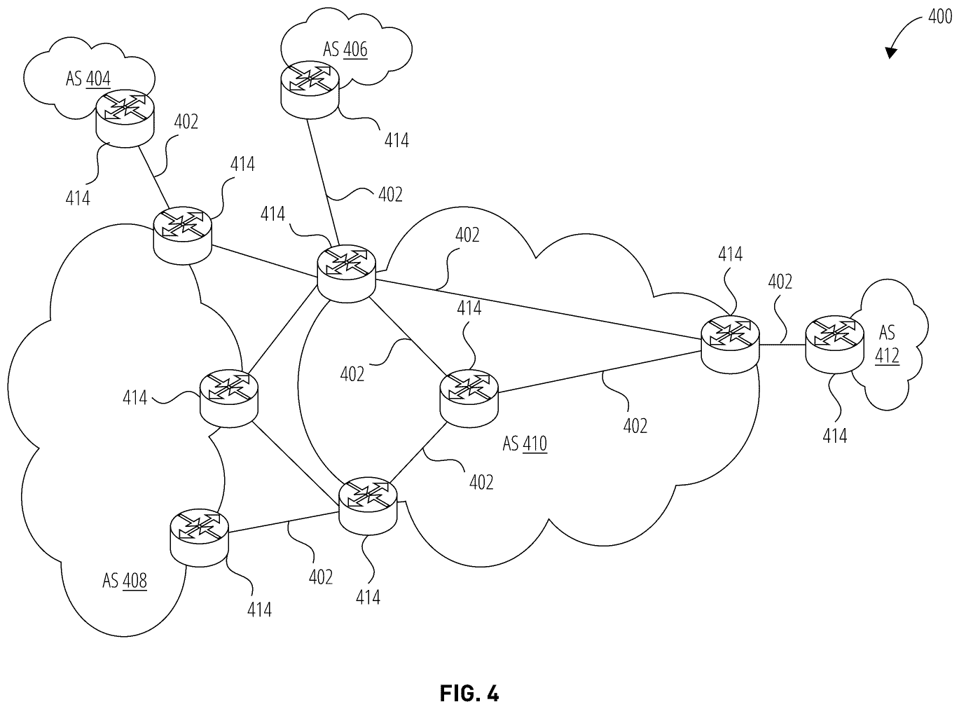

FIG. 4 is a schematic block diagram of an example computer network 400 illustratively comprising network devices 414 interconnected by various methods of communication. For instance, the links 402 may be any suitable combination of wired links and shared media (e.g., wireless links, Internet Exchange Points, etc.) where certain network devices 414, such as, e.g., routers, computers, etc., may be in communication with other network devices 414, e.g., based on distance, signal strength, current operational status, location, etc. Those skilled in the art will understand that any number of network devices 414, links, etc. may be used in the computer network, and that the view shown herein is for simplicity.

Data packets (e.g., traffic and/or messages sent between the network devices 414) may be exchanged among the network devices 414 of the computer network 400 using predefined network communication protocols such as certain known wired protocols, as well as wireless protocols or other shared-media protocols where appropriate.

The computer network 400 includes a set of autonomous systems (AS) labeled as AS 404, AS 406, AS 408, AS 410, and AS 412. The computer network 400 may be positioned in any suitable network environment or communications architecture that operates to manage or otherwise direct information using any appropriate routing protocol or data management standard. For example, computer network 400 may be provided in conjunction with a border gateway protocol (BGP).

As noted above, an AS may be a collection of connected Internet Protocol (IP) routing network devices 414 under the control of one or more network operators that presents a common, clearly defined routing policy to a network (e.g., the Internet). Usually, an AS comprises network control appliances 114 that are established on the edge of the system, and that serve as the system's ingress and egress points for network traffic. Moreover, the network devices 414 may be considered edge network devices, border routers, or core network devices within the respective AS. These network devices typically, but not always, are routers or any other element of network infrastructure suitable for switching or forwarding data packets according to a routing protocol or switching protocol. For the purposes of the present disclosure, the network devices 414 located within an AS may alternatively be referred to as “forwarding network devices” or “intermediate network devices.” Moreover, for illustration purposes, the AS 404, AS 406, AS 408, AS 410, and AS 412 are shown with a limited number of network devices 414. In an actual implementation, however, an AS normally comprises numerous routers, switches, and other elements.

Each AS 404, AS 406, AS 408, AS 410, and AS 412 may be associated with an Internet Service provider (ISP). Even though there may be multiple ASes supported by a single ISP, the Internet only sees the routing policy of the ISP. That ISP must have an officially registered Autonomous System Number (ASN). As such, a unique ASN is allocated to each AS for use in BGP routing. ASNs are important primarily because they uniquely identify each network on the Internet.

To facilitate the routing of network traffic through the ASes, or more specifically, the network devices 414 within the ASes, the network devices may exchange routing information to various network destinations. As described above, BGP is conventionally used to exchange routing and reachability information among network devices 414 within a single AS or between different ASes. One particular example of BGP is BGPv4, as defined in Request for Comments (RFC) 1771 of the Internet Engineering Task Force (IETF). Various embodiments may implement other versions of BGP, however, and the use of BGPv4 is not required. The BGP logic of a router is used by the data collectors to collect BGP AS path information, e.g., the “AS PATH” attribute, as described further below, from BGP tables of border routers of an AS, to construct paths to prefixes.

To exchange BGP routing information, two BGP hosts (network devices 414), or peers, first establish a transport protocol connection with one another. Initially, the BGP peers exchange messages to open a BGP session, and, after the BGP session is open, the BGP peers exchange their entire routing information. Thereafter, in certain embodiments, only updates or changes to the routing information, e.g., the “BGP UPDATE” attribute, are exchanged, or advertised, between the BGP peers. The exchanged routing information is maintained by the BGP peers during the existence of the BGP session.

The BGP routing information may include the complete route to each network destination, e.g., “destination network device,” that is reachable from a BGP host. A route, or path, comprises an address destination, which is usually represented by an address prefix (also referred to as prefix), and information that describe the path to the address destination. The address prefix may be expressed as a combination of a network address and a mask that indicates how many bits of the address are used to identify the network portion of the address. In Internet Protocol version 4 (IPv4) addressing, for example, the address prefix can be expressed as “9.2.0.2/16”. The “/16” indicates that the first 16 bits are used to identify the unique network leaving the remaining bits in the address to identify the specific hosts within this network.

A path joining a plurality of ASes, e.g., links 402, may be referred to as an “AS_PATH.” The AS_PATH attribute indicates the list of ASes that must be traversed to reach the address destination. For example, as illustrated in FIG. 4, the AS 412 may store an AS_PATH attribute of “404 406 410 412” where the address destination is the AS 412 (or a particular IP address within AS 412). Here, the AS_PATH attribute indicates that the path to the address destination AS 412 from AS 408 passes through AS 404, AS 406 and AS 410, in that order.

Although it may be preferable that all network devices 414 in the respective ASes be configured according to BGP, in a real-world implementation, it may be unlikely that each network device communicates using BGP. Thus, the disclosed embodiments are applicable to scenarios where all network devices 414 in the computer network 400 are configured according to BGP, as well as scenarios where only a subset of the network devices 414 is configured as such. Moreover, between any of the ASes, there may be a link 402, e.g., between AS 404 and AS 408, as shown in FIG. 4, or there may be multiple links 402, e.g., between AS 408 and AS 410. Thus, the disclosed embodiments are applicable to either case, as described in further detail below.

Moreover, a security extension to the BGP has been developed, referred to as BGPSEC, which provides improved security for BGP routing. BGP does not include mechanisms that allow an AS to verify the legitimacy and authenticity of BGP route advertisements. The Resource Public Key Infrastructure (RPKI) provides a first step towards addressing the validation of BGP routing data. BGPSEC extends the RPKI by adding an additional type of certificate, referred to as a BGPSEC router certificate, that binds an AS number to a public signature verification key, the corresponding private key of which is held by one or more BGP speakers within this AS. Private keys corresponding to public keys in such certificates can then be used within BGPSEC to enable BGP speakers to sign on behalf of their AS. The certificates thus allow a relying party to verify that a BGPSEC signature was produced by a BGP speaker belonging to a given AS. Thus, a goal of BGPSEC is to use signatures to protect the AS Path attribute of BGP update messages so that a BGP speaker can assess the validity of the AS Path in update messages that it receives. It should be understood, however, that the embodiments for implementing AS Path security disclosed herein are not limited to BGPSEC; certain embodiments may, additionally or alternatively, be applicable to other suitable protocols, including, for example, SoBGP, S-BGP, and PGPBGP, to name just a few.

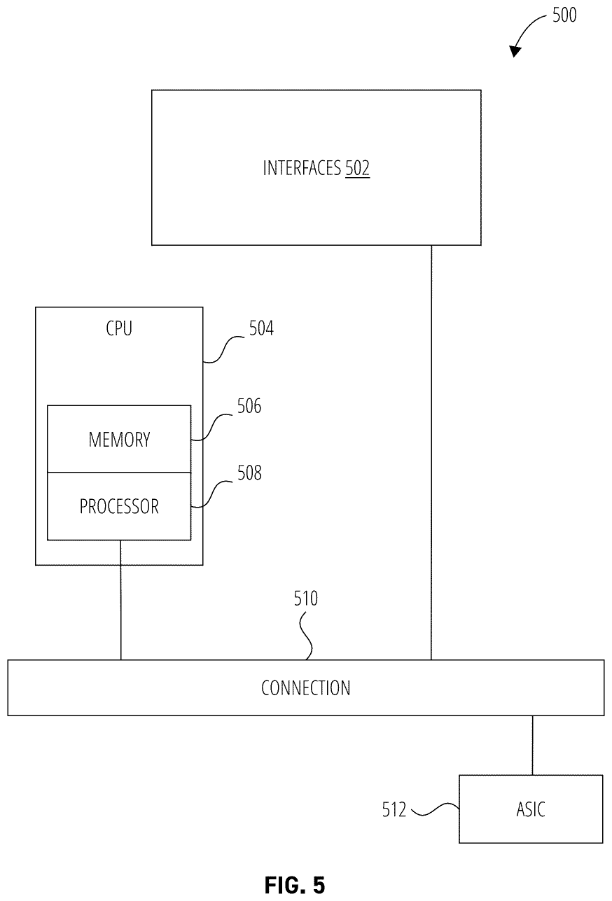

FIG. 5 illustrates an example network device 500 suitable for performing switching, routing, load balancing, and other networking operations. The example network device 500 can be implemented as switches, routers, nodes, metadata servers, load balancers, client devices, and so forth.

Network device 500 includes a central processing unit (CPU) 504, interfaces 502, and a bus 510 (e.g., a PCI bus). When acting under the control of appropriate software or firmware, the CPU 504 is responsible for executing packet management, error detection, and/or routing functions. The CPU 504 preferably accomplishes all these functions under the control of software including an operating system and any appropriate applications software. CPU 504 may include one or more processors 508, such as a processor from the INTEL X86 family of microprocessors. In some cases, processor 508 can be specially designed hardware for controlling the operations of network device 500. In some cases, a memory 506 (e.g., non-volatile RAM, ROM, etc.) also forms part of CPU 504. However, there are many different ways in which memory could be coupled to the system.

The interfaces 502 are typically provided as modular interface cards (sometimes referred to as “line cards”). Generally, they control the sending and receiving of data packets over the network and sometimes support other peripherals used with the network device 500. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LORA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communication intensive tasks, these interfaces allow the master CPU (e.g., 504) to efficiently perform routing computations, network diagnostics, security functions, etc.

Although the system shown in FIG. 5 is one specific network device of the present disclosure, it is by no means the only network device architecture on which the present disclosure can be implemented. For example, an architecture having a single processor that handles communications as well as routing computations, etc., is often used. Further, other types of interfaces and media could also be used with the network device 500.

Regardless of the network device's configuration, it may employ one or more memories or memory modules (including memory 506) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 506 could also hold various software containers and virtualized execution environments and data.

The network device 500 can also include an application-specific integrated circuit (ASIC) 512, which can be configured to perform routing and/or switching operations. The ASIC 512 can communicate with other components in the network device 500 via the bus 510, to exchange data and signals and coordinate various types of operations by the network device 500, such as routing, switching, and/or data storage operations, for example.
Aspect 1. A method comprising establishing, by a first node of a high availability cluster, a first stateless virtual private network (VPN) designating the first node as an active node and designating a second node of the HA cluster as a standby node; establishing, by the first node of the HA cluster, a second stateless VPN designating the first node as the standby node and the second node as the active node; receiving a packet at the first node within the first stateless VPN; transmitting the packet from the first node; and receiving the packet at the first node from the second node after the packet was received at the second node as return traffic.
Aspect 2. The method of Aspect 1, wherein the receiving the packet at the first node from the second node is conducted across an HA peer link of the HA cluster.
Aspect 3. The method of any one of Aspects 1-2, further comprising transmitting the packet out of the HA cluster with the first node after receiving the packet from the second node.
Aspect 4. The method of any one of Aspects 1-3, wherein the first stateless VPN and second stateless VPN designate the active node as a routing device responsible for routing traffic that is more critical than traffic routed by the standby node.
Aspect 5. The method of any one of Aspects 1-4, further comprising determining which of the first node and the second node is the active node, and receiving the packet at the active node.
Aspect 6. The method of any one of Aspects 1-5, wherein the determining is conducted by inspecting a label of the packet and determining that the label designates the first stateless VPN or the second stateless VPN as a VPN responsible for routing the packet.
Aspect 7. The method of any one of Aspects 1-6, wherein the standby node performs packet processing on the packet.
Aspect 8. A first node of a high availability (HA) cluster, the first node comprising a storage configured to store instructions; and at least one processor configured to execute the instructions and cause the at least one processor to establish, by the first node of the HA cluster, a first stateless virtual private network (VPN) designating the first node as an active node and designating a second node of the HA cluster as a standby node; establish, by the first node of the HA cluster, a second stateless VPN designating the first node as the standby node and the second node as the active node; receive a packet at the first node within the first stateless VPN; transmit the packet from the first node; and receive the packet at the first node from the second node after the packet was received at the second node as return traffic.
Aspect 9. The network device of Aspect 8, wherein the packet is received at the first node from the second node across an HA peer link of the HA cluster.
Aspect 10. The network device of any one of Aspects 8-9, wherein the instructions further cause the processor to transmit the packet out of the HA cluster with the first node after receiving the packet from the second node.
Aspect 11. The network device of any one of Aspects 8-10, wherein the first stateless VPN and second stateless VPN designate the active node as a routing device responsible for routing traffic that is more critical than traffic routed by the standby node.
Aspect 12. The network device of any one of Aspects 8-11, wherein the instructions further cause the processor to determine which of the first node and the second node is the active node.
Aspect 13. The network device of any one of Aspects 8-12, wherein the instructions to determine which of the first node and the second node is the active node includes inspecting a label of the packet and determining that the label designates the first stateless VPN or the second stateless VPN as a VPN responsible for routing the packet.
Aspect 14. The network device of any one of Aspects 8-14, wherein the standby node performs packet processing on the packet.
Aspect 15. A non-transitory computer-readable storage medium including instructions that, when executed by at least one processor, cause the least one processor to: establish, by a first node of a high availability (HA) cluster, a first stateless virtual private network (VPN) designating the first node as an active node and designating a second node of the HA cluster as a standby node; establish, by the first node of the HA cluster, a second stateless VPN designating the first node as the standby node and the second node as the active node; receive a packet at the first node within the first stateless VPN; transmit the packet from the first node; and receive the packet at the first node from the second node after the packet was received at the second node as return traffic.
Aspect 16. The non-transitory computer-readable storage medium of Aspect 15, wherein the packet is received at the first node from the second node across an HA peer link of the HA cluster.
Aspect 17. The non-transitory computer-readable storage medium of any one of Aspects 15-16, wherein the instructions further cause the processor to transmit the packet out of the HA cluster with the first node after receiving the packet from the second node.
Aspect 18. The non-transitory computer-readable storage medium of Aspects 15-17, wherein the first stateless VPN and second stateless VPN designate the active node as a routing device responsible for routing traffic that is more critical than traffic routed by the standby node.
Aspect 19. The non-transitory computer-readable storage medium of Aspects 15-18, wherein the instructions further cause the processor to determine which of the first node and the second node is the active node.
Aspect 20. The non-transitory computer-readable storage medium of Aspects 15-19, wherein the instructions to determine which of the first node and the second node is the active node includes inspecting a label of the packet and determining that the label designates the first stateless VPN or the second stateless VPN as a VPN responsible for routing the packet.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method comprising:
establishing, by a first node of a high availability cluster (HA cluster), a first stateless virtual private network (first stateless VPN) designating the first node as an active node and designating a second node of the HA cluster as a standby node;
establishing, by the first node of the HA cluster, a second stateless VPN designating the first node as the standby node and the second node as the active node;
receiving a packet at the first node within the first stateless VPN;
transmitting the packet from the first node; and
receiving the packet at the first node from the second node after the packet was received at the second node as return traffic.

2. The method of claim 1, wherein receiving the packet at the first node from the second node is conducted across an HA peer link of the HA cluster.

3. The method of claim 1, further comprising transmitting the packet out of the HA cluster with the first node after receiving the packet from the second node.

4. The method of claim 1, wherein the first stateless VPN and the second stateless VPN designate the active node as a routing device responsible for routing traffic that is more critical than the traffic routed by the standby node.

5. The method of claim 1, further comprising determining which of the first node and the second node is the active node, and receiving the packet at the active node.

6. The method of claim 5, wherein determining which of the first node and the second node is the active node is conducted by inspecting a label of the packet and determining that the label designates the first stateless VPN or the second stateless VPN as a VPN responsible for routing the packet.

7. The method of claim 1, wherein the standby node performs packet processing on the packet.

8. A first node of a HA cluster, the first node comprising:
a storage configured to store instructions; and
at least one processor configured to execute the instructions and cause the at least one processor to:
establish, by the first node of the HA cluster, a first stateless VPN designating the first node as an active node and designating a second node of the HA cluster as a standby node;
establish, by the first node of the HA cluster, a second stateless VPN designating the first node as the standby node and the second node as the active node;
receive a packet at the first node within the first stateless VPN;
transmit the packet from the first node; and
receive the packet at the first node from the second node after the packet was received at the second node as return traffic.

9. The first node of claim 8, wherein the packet is received at the first node from the second node across an HA peer link of the HA cluster.

10. The first node of claim 8, wherein the instructions further cause the at least one processor to transmit the packet out of the HA cluster with the first node after receiving the packet from the second node.

11. The first node of claim 8, wherein the first stateless VPN and the second stateless VPN designate the active node as a routing device responsible for routing traffic that is more critical than traffic routed by the standby node.

12. The first node of claim 8, wherein the instructions further cause the at least one processor to determine which of the first node and the second node is the active node.

13. The first node of claim 12, wherein the instructions to determine which of the first node and the second node is the active node includes inspecting a label of the packet and determining that the label designates the first stateless VPN or the second stateless VPN as a VPN responsible for routing the packet.

14. The first node of claim 8, wherein the standby node performs packet processing on the packet.

15. A non-transitory computer-readable storage medium including instructions that, when executed by at least one processor, cause the at least one processor to:
establish, by a first node of a HA cluster, a first stateless VPN designating the first node as an active node and designating a second node of the HA cluster as a standby node;
establish, by the first node of the HA cluster, a second stateless VPN designating the first node as the standby node and the second node as the active node;
receive a packet at the first node within the first stateless VPN;
transmit the packet from the first node; and
receive the packet at the first node from the second node after the packet was received at the second node as return traffic.

16. The non-transitory computer-readable storage medium of claim 15, wherein the packet is received at the first node from the second node across an HA peer link of the HA cluster.

17. The non-transitory computer-readable storage medium of claim 15, wherein the instructions further cause the at least one processor to transmit the packet out of the HA cluster with the first node after receiving the packet from the second node.

18. The non-transitory computer-readable storage medium of claim 15, wherein the first stateless VPN and the second stateless VPN designate the active node as a routing device responsible for routing traffic that is more critical than traffic routed by the standby node.

19. The non-transitory computer-readable storage medium of claim 15, wherein the instructions further cause the at least one processor to determine which of the first node and the second node is the active node.

20. The non-transitory computer-readable storage medium of claim 15, wherein the instructions to determine which of the first node and the second node is the active node includes inspecting a label of the packet and determining that the label designates the first stateless VPN or the second stateless VPN as a VPN responsible for routing the packet.
